(19) United States
(12) Patent Application Publication
(10) Pub. No.: US 2011/0097241 A1
(43) Pub. Date: Apr. 28, 2011

(54) BIOSENSOR AND METHOD FOR MAKING SAME

(76) Inventors: Gou-Jen WANG, Taichung (TW); Yu-Ta LIN, Banqiao (TW)

(21) Appl. No.: 12/815,612

(22) Filed: Jun. 15, 2010

(30) Foreign Application Priority Data
Oct. 26, 2009 (TW) 098136102

(51) Int. Cl. C25D 15/00; G01N 27/00

(52) U.S. Cl. 422/82.01; 205/109

(57) ABSTRACT

The present invention relates to a biosensor having a substrate, a thin-film electrode and multiple nanoparticles. The substrate has a substrate surface. The substrate surface has multiple hemispherical protrusions. The thin-film electrode is formed on the substrate surface and has multiple hemispherical surfaces. The multiple nanoparticles are electrochemically deposited on the hemispherical surfaces. The hemispherical surfaces of the thin-film electrode enlarge an area available for binding on a surface of each of the nanoparticles. The enlarged area of the nanoparticles raises the sensitivity of the biosensor and shortens detection time. The present invention also relates to a method for making the aforementioned biosensor.

### BACKGROUND OF THE INVENTION

1. Field of the Invention

The present invention relates to a biosensor with electrochemically deposited nanoparticles. The present invention also relates to a method for making a biosensor with electrochemically deposited nanoparticles.

2. Description of the Prior Art

A conventional biosensor comprises 1) a biological detector, 2) an energy converter and 3) a signal processor. The biological detector may be an antibody, a receptor, an enzyme, a single-stranded DNA or an artificial receptor for selectively combining an analyte. The energy converter is a device for converting a physical or chemical energy of the analyte into one of various electric signals, especially voltage and current signals. The signal processor processes the electric signal from the energy converter and outputs readable information, for example, a graph of time-current, time-potential or impedance spectroscopy. The signal processor may further function as a filter for filtering out interfering noises.

Biosensors operate using various biosensing methods. Biosensing methods are categorized into optical sensing methods and electrical sensing methods by their energy-converting mechanisms. Optical biosensors include biosensors utilizing enzyme-linked immunosorbent assay (ELISA) and surface-plasmon resonance (SPR). Electrical biosensors are primarily piezoelectric.

Optical biosensors, for example, biosensors utilizing ELISA, are well developed and available for various fields. However, an optical biosensor requires numerous detecting steps and a large volume of a reaction solution. Furthermore, the detection performed with an optical biosensor takes a long reaction time to complete. Unavoidable lags, which produce unwanted artifacts, occur during the time period between addition of signal-producing substrates and reading of values.

In contrast, a piezoelectric biosensor utilizes antibodies attached to a surface of a piezoelectric detector. A reading machine measures and reads slight resonant frequency alternations of the piezoelectric detector when antigens bind to the antibodies. The advantages of a piezoelectric biosensor come from simple detecting mechanisms and easy-to-detect electric signals. However, complicate manufacture processes for making piezoelectric biosensors are a serious drawback.

To overcome the shortcomings, the present invention provides a biosensor and a method for making same to mitigate or obviate the aforementioned problems.

### SUMMARY OF THE INVENTION

The main objective of the invention is to provide a biosensor and a method for making same.

A biosensor in accordance with the present invention has a substrate, a thin-film electrode and uniformly deposited nanoparticles.

The substrate comprises a substrate surface. The substrate surface comprises multiple hemispherical protrusions. The thin-film electrode is formed on the substrate surface and comprises multiple hemispherical surfaces. The multiple nanoparticles are electrochemically deposited on the hemispherical surfaces.

The hemispherical surfaces of the thin-film electrode enlarge an area available for binding on a surface of each of the nanoparticles electrochemically deposited thereon. Along with radiating lines of electric force of the thin-film electrode energized during an electrochemical deposition process, the nanoparticles are densely and evenly distributed on the hemispherical surfaces without addition of any reducing agent and stabilizer. The sensitivity of the biosensor is raised by the enlarged area on the surface of each nanoparticle and even distribution of the nanoparticles on the hemispherical surface. The biosensor may be further enlarged to expand available area for detection reactions.

Another aspect of the present invention relates to a method for making a biosensor comprising preparing a substrate, wherein the substrate comprises a substrate surface comprising multiple hemispherical protrusions; sputter depositing a thin-film electrode on the substrate surface with a metal sputtering target, wherein the thin-film electrode comprises multiple hemispherical surfaces; and electrochemically-depositing multiple nanoparticles on the hemispherical surfaces. The method is suitable for making a biosensor in accordance with the present invention that provides aforementioned advantages.

Other objectives, advantages and novel features of the invention will become more apparent from the following detailed description when taken in conjunction with the accompanying drawings.

### BRIEF DESCRIPTION OF THE DRAWINGS

FIG. 1 is a flowchart of a method in accordance with the present invention;

FIG. 2 is a cross sectional side view of a substrate of the biosensor in accordance with the present invention;

FIG. 3 is a cross sectional side view of a substrate and a thin-film electrode of the biosensor in accordance with the present invention;

FIG. 4 is a cross sectional side view of the biosensor in accordance with the present invention;

FIG. 5 is an operational cross sectional side view of the biosensor in accordance with the present invention during a process of electrochemically depositing nanoparticles on the hemispherical surfaces of the thin-film electrode;

FIG. 6 is a cross sectional side view of the biosensor in accordance with the present invention;

FIG. 7 is a schematically illustrated side view in partial section of the biosensor in FIG. 6 that has been processed with MUA;

FIG. 8 is a schematically illustrated cross sectional side view of the biosensor in FIG. 7 that has been processed with EDC and NHS;

FIG. 9 is a cross sectional side view of the biosensor in FIG. 8 with an avidin molecule schematically illustrated as a blank cross;

FIG. 10 is a cross sectional side view of the biosensor in FIG. 9 with biotin molecules schematically illustrated as squares each having a hanging stem;

FIG. 11 is an impedance spectroscopy graph of detecting various analytes with the biosensor in accordance with the present invention;

FIG. 12 is a microscopic image of a substrate surface of the biosensor in accordance with the present invention;

FIG. 13 is a microscopic image of nanoparticles electrochemically deposited on hemispherical surfaces of a thin-film electrode of the biosensor in accordance with the present invention; and

FIG. 14 is another microscopic image of the biosensor in FIG. 13.

### DETAILED DESCRIPTION OF THE PREFERRED EMBODIMENTS

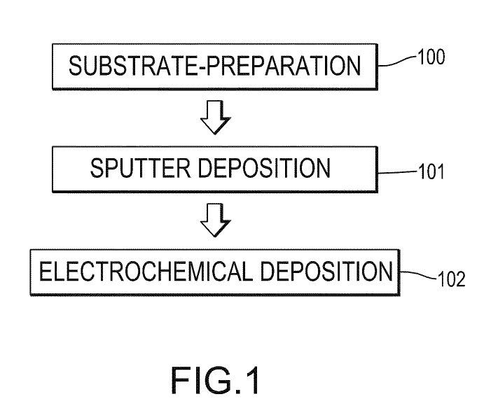

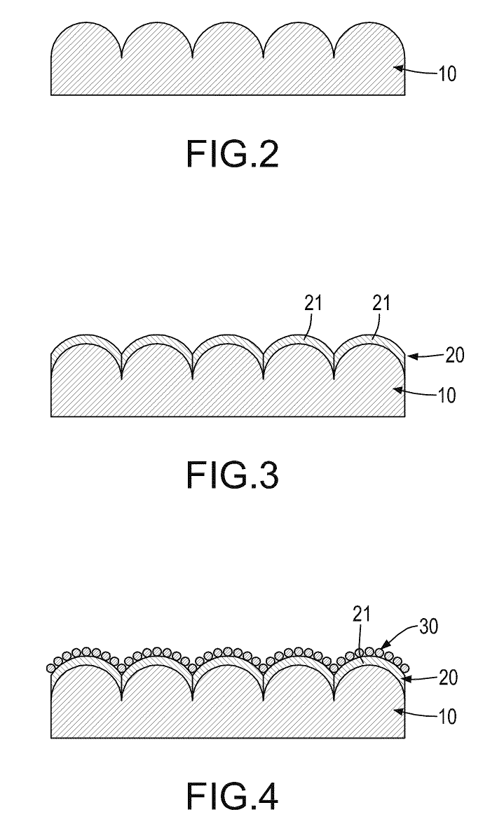

With reference to FIGS. 1-4, a biosensor in accordance with the present invention has a substrate 10, a thin-film electrode 20 and multiple nanoparticles 30.

The substrate 10 comprises a substrate surface. The substrate surface comprises multiple hemispherical protrusions. Preferably, the substrate is a hemispherical nanostructural array. The thin-film electrode 20 is formed on the substrate surface and comprises multiple hemispherical surfaces 21. The hemispherical surfaces 21 are connected with one another and correspondingly cover the protrusions of the substrate surface. The multiple nanoparticles 30 are electrochemically deposited on the hemispherical surfaces 21. Preferably, the nanoparticles 30 are electrophoretically deposited on the hemispherical surfaces 21.

A method for making the aforementioned biosensor in accordance with the present invention comprises a substrate-preparation step 100, a sputter deposition step 101 and an electrochemical deposition step 102.

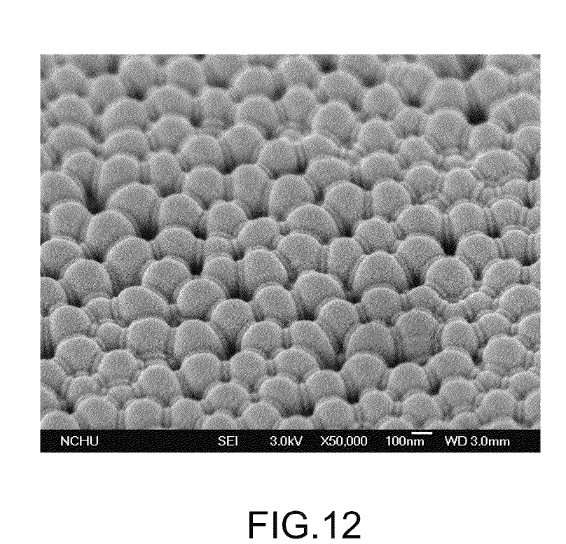

With further reference to FIG. 12, the substrate-preparation step 100 relates to preparing a substrate 10 with photoelectric, physical or chemical means, wherein the substrate 10 comprises a substrate surface. The substrate surface comprises multiple hemispherical protrusions.

The sputter deposition step 101 relates to sputter depositing a thin-film electrode 20 on the substrate with a metal sputtering target. The metal sputtering target is made from a metal material. The metal material may be gold, titanium or silver.

In a preferred embodiment, a distance between the substrate 10 and the metal sputtering target is from 2 cm to 10 cm, and the thin-film electrode 20 is sputter deposited on the substrate surface in a vacuity from 4×10⁻³ torr to 3×10⁻⁴ torr, at a temperature from 20° C. to 40° C., with an airflow of argon from 10 sccm to 60 sccm, with a power from 50 W to 150 W, for 1 minute to 10 minutes.

In order to raise electrical stability, the sputter deposited thin-film electrode 20 is annealed by heating the chip 10 from 150° C. to 400° C. for 0.5 hour to 2 hours before cooling to room temperature.

With the foregoing process of the sputter deposition step 101, multiple hemispherical surfaces 21 corresponding to hemispherical protrusions are formed on the thin-film electrode 20.

The electrochemical deposition step 102 relates to electrochemical-depositing multiple nanoparticles 30 on the hemispherical surfaces 21. The nanoparticles 30 are lead by an electrochemical force to the hemispherical surfaces and deposited thereon.

A biosensor in accordance with the present invention is obtained by performing the substrate-preparation step 100, the sputter deposition step 101 and the electrochemical deposition step 102 as described above.

In a preferred embodiment, each of the nanoparticles comprises a diameter from 10 nm to 200 nm. Furthermore, the electrochemical deposition step 102, during which a deposition rate is relative to diameters and reduction potentials of sediments, comprises below listed steps.

1) The first step relates to preparing a 0.02 M to 1 M tetrachloroaurate solution with deionized water.

2) The second step relates to adding 1 mL of the tetrachloroaurate solution to 40 mL to 500 mL ultrapure water.

3) The third step relates to triode-connection of an electrochemical analyzer and an electrochemical tank, wherein the thin-film electrode 20 sputter deposited on the substrate 10 is used as a work electrode (WE). A silver/silver chloride reference electrode (RE) and a platinum counter electrode (CE) are used in the third step.

4) The forth step relates to applying a −0.2 V to −0.8 V DC power and allowing the deposition time to be 50 seconds to 600 seconds. In the forth step, the deposition occurs on the WE, while the RE is used to control a potential of the WE and the CE is used to collect the rest half of the reacting current.

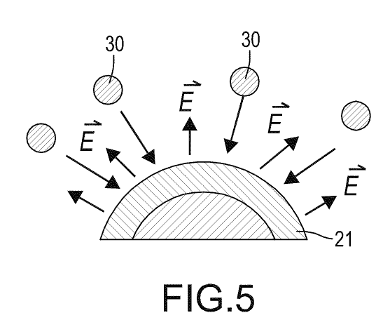

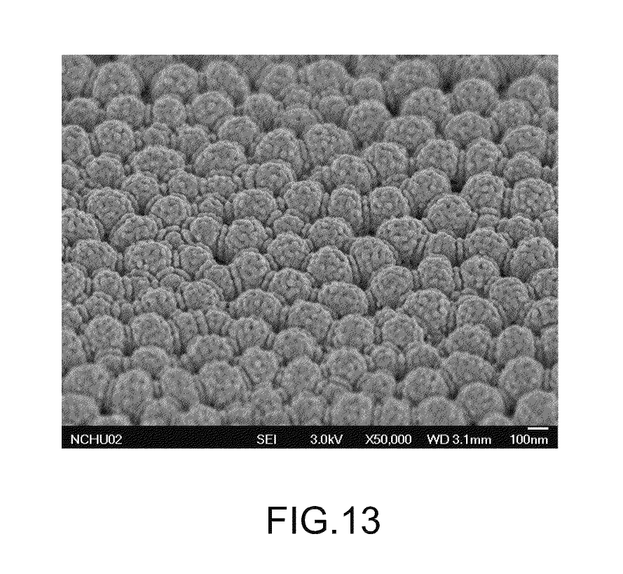

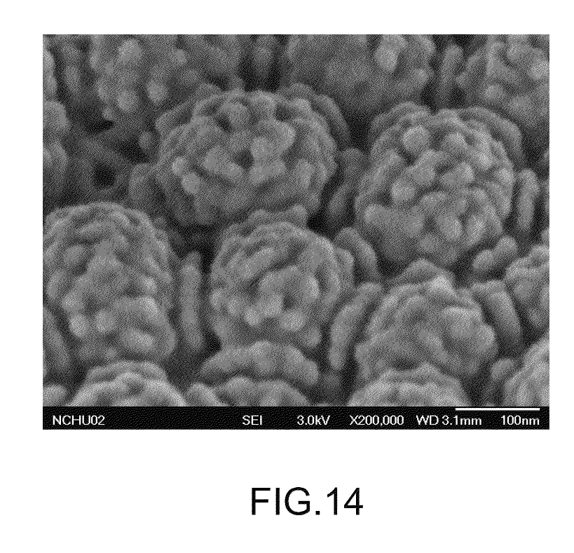

With reference to FIG. 5, when electrically energized, the lines of electric force are distributed on and perpendicular to the hemispherical surfaces of the thin-film electrode 20. Lines of electric force of a conventional flat thin-film electrode are parallel and tend to cause aggregation of nanoparticles 30 during an electrochemical deposition process. On the contrary, when the thin-film electrode 20 comprising hemispherical surfaces is electrically energized, the lines of electric force are distributed on and radiate from the hemispherical surfaces. The radially radiating lines of electric force apply an electric field force to the nanoparticles 30 that carrying negative potential, wherein the electric field force is stronger than interacting forces between the nanoparticles 30. With further reference to FIGS. 13 and 14, the stronger electric field force effectively isolates each nanoparticle 30 and prevents aggregation thereof. Thus, these isolated nanoparticles 30 are densely and evenly distributed on the hemispherical surfaces without addition of reducing agent and stabilizer, and provide an enlarged area for contacting signal-producing substrates.

A process of using the biosensor in accordance with the present invention may comprise following steps.

1) Immersing the biosensor in a solution containing analytes and allowing the nanoparticles of the biosensor to interact with the analytes.

2) Placing the biosensor having been interacted with the analytes in a buffer solution, 2-[N-Morpholino] ethanesulfonic acid (MES) and analyzing the alternation of electric signals with a wired impedance analyzer.

The binding of the biosensor and an analyte generates a shift in a graph of impedance spectroscopy and provides detection information.

The biosensor in accordance with the present invention electrochemically detects various analytes with impedance analysis. The binding of an analyte to the nanoparticles of the biosensor generates a shift in the graph of impedance spectroscopy for determine a binding state of the nanoparticles and the analytes. The application of the biosensor is capable of detecting various analytes.

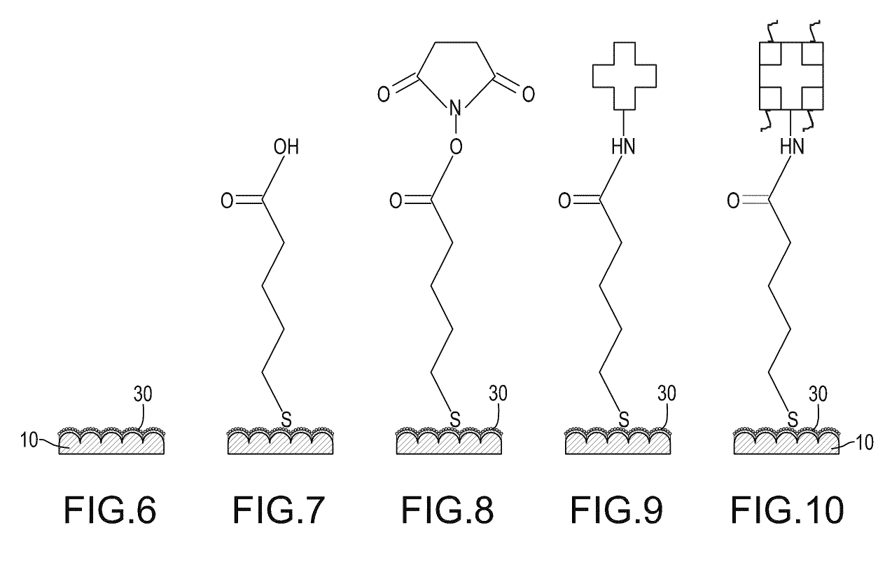

With reference to FIGS. 6-10, modifications may be made to the biosensor for detection of different analytes. A process for modifying and using the biosensor may comprise the blow listed steps.

1) Sequentially immersing a biosensor in alcohol, acetone and deionized water and then washing the biosensor in an ultrasonic cleaner for 3 minutes to 15 minutes.

2) Making an alcohol solution containing 10 mM to 50 mM 11-mercaptoundecanoic acid (11-MUA), dropping 1 mL of the 11-MUA alcohol solution onto the biosensor with drop method and then allowing volatilization for 3 minutes to 15 minutes.

3) Placing the biosensor in a MES buffer solution for 0.5 hour to 1 hours to activate acidic group (COOH), wherein the MES buffer solution contains 50 mM of N-hydroxysuccinimide (NHS) and 100 mM to 500 mM 1-Ethyl-3-(3-dimethylaminopropyl)-carbodiimide (EDC).

4) Washing with deionized water.

5) Dropping 1 mg/mL to 10 mg/mL avidin solution onto the biosensor and allowing the biosensor to stand for 10 minutes to 60 minutes to fix biotin specific elements.

6) Placing the biosensor in PBS having biotin analytes diluted at 1 ng/mL to 100 ug/mL for 4 hours to 16 hours.

7) Placing the biosensor in a MES buffer solution and detecting with a DC power from 0.2 V to 1V at DC frequency of 100 kHz to 0.1 Hz and an AC power from 5 mV to 50 mV.

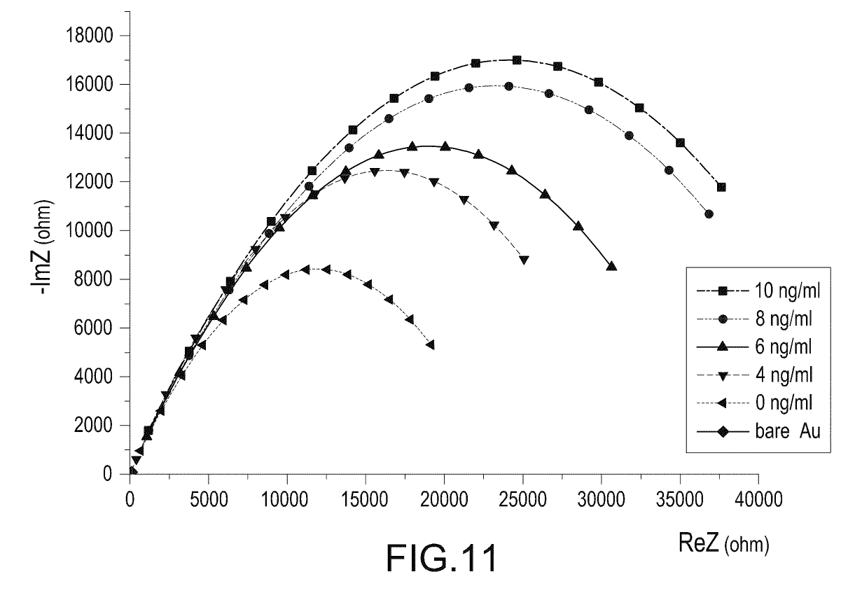

With reference to FIG. 11, a graph of impedance spectroscopy obtained with the aforementioned process for modifying and using the biosensor demonstrates the ability of the biosensor to detect various analytes.

The biosensor in accordance with the present invention comprises a thin-film electrode comprising hemispherical surfaces. The hemispherical surfaces of the thin-film electrode enlarge an area available for binding on a surface of each of the nanoparticles electrochemically deposited thereon. The nanoparticles with enlarged area for binding are evenly distributed on the hemispherical surfaces to raise detection rate and shorten detention time.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A biosensor comprising
a substrate comprising
a substrate surface comprising
multiple hemispherical protrusions;
a thin-film electrode formed on the substrate surface and comprising
multiple hemispherical surfaces; and
multiple nanoparticles electrochemically deposited on the hemispherical surfaces.

2. The biosensor as claimed in claim 1, wherein the thin-film electrode comprises
a thickness from 10 nm to 1 μm.

3. The biosensor as claimed in claim 1, wherein each nanoparticle comprises
a diameter from 10 nm to 200 nm.

4. The biosensor as claimed in claim 2, wherein each nanoparticle comprises
a diameter from 10 nm to 200 nm.

5. A method for making a biosensor comprising
preparing a substrate, wherein the substrate comprises a substrate surface comprising multiple hemispherical protrusions;
sputter depositing a thin-film electrode on the substrate surface with a metal sputtering target, wherein the thin-film electrode comprises multiple hemispherical surfaces; and
electrochemical-depositing multiple nanoparticles on the hemispherical surfaces.

6. The method as claimed in claim 5, wherein the metal sputtering target is made from a metal material selected from a group consisting of gold, titanium and silver.

7. The method as claimed in claim 5, wherein a distance between the substrate and the metal sputtering target is from 2 cm to 10 cm; and
the thin-film electrode is sputter deposited on the substrate surface in a vacuity from 4×10⁻³ torr to 3×10⁻⁴ torr, at a temperature from 20° C. to 40° C., with an airflow of argon from 10 sccm to 60 sccm, with a power from 50 W to 150 W, for 1 minute to 10 minutes.

8. The method as claimed in claim 6, wherein a distance between the substrate and the metal sputtering target is from 2 cm to 10 cm; and
the thin-film electrode is sputter deposited on the substrate surface in a vacuity from 4×10⁻³ torr to 3×10⁻⁴ torr, at a temperature from 20° C. to 40° C., in an airflow of argon is 10 sccm to 60 sccm, with a power from 50 W to 150 W, for 1 minute to 10 minutes.

9. The method as claimed in claim 7, wherein the sputter deposited thin-film electrode is annealed by heating the chip from 150° C. to 400° C. for 0.5 hour to 2 hours before cooling to room temperature.

10. The method as claimed in claim 8, wherein the sputter deposited thin-film electrode is annealed by heating the chip from 150° C. to 400° C. for 0.5 hour to 2 hours before cooling to room temperature.
